(19) United States
(12) Patent Application Publication
(10) Pub. No.: US 2026/0303656 A1
(43) Pub. Date: Oct. 1, 2026

(54) INFORMATION PROCESSING DEVICE, INFORMATION PROCESSING METHOD, AND RECORDING MEDIUM

(71) Applicant: Panasonic Automotive Systems Co., Ltd., Kanagawa (JP)

(72) Inventors: Tomonori MITSUGI, Tokyo (JP); Ryo HIRANO, Osaka (JP)

(73) Assignee: Panasonic Automotive Systems Co., Ltd., Kanagawa (JP)

(21) Appl. No.: 19/450,140

(22) Filed: Jan. 15, 2026

(30) Foreign Application Priority Data
Mar. 26, 2025 (JP) 2025-052155

(51) Int. Cl. H04L 9/40

(52) U.S. Cl. CPC H04L 63/1441; H04L 63/1433

(57) ABSTRACT

An information processing device includes, for an electronic control unit mounted in a moving body, two or more separate areas. The information processing device includes an obtainer that obtains a result of monitoring communications between the two or more separate areas; a response determiner that determines one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and an outputter that outputs information for taking the one countermeasure.

### CROSS REFERENCE TO RELATED APPLICATION

The present application is based on and claims priority of Japanese Patent Application No. 2025-052155 filed on Mar. 26, 2025.

### FIELD

The present disclosure relates to an information processing device, an information processing method, and a recording medium.

### BACKGROUND

With the progress of “Connected,” “Autonomous, “Shared & Services,” and “Electric” (C.A.S.E.) vehicles, a controller area network (CAN) or Ethernet (registered trademark) that is a network inside the vehicle is often connected to a smartphone or an external server through Wi-Fi (registered trademark), Bluetooth (registered trademark), or cellular vehicle to X (V2X) that is a network outside the vehicle. For example, electric automobiles are often connected cars to manage charging status, and the batteries may be in danger if tampered. Countermeasure are to be taken against threats from the outside of the vehicle.

Patent Literature (PTL) 1 discloses a security device that can quickly implement a suitable attack response in accordance with the risk level of an attack on a device network.

### Citation List

### Patent Literature

PTL 1: International Patent Publication WO 2021-019635

### SUMMARY

An information processing device against a security risk, such as a cyberattack, can be improved upon.

In view of the above, the present disclosure provides an information processing device, an information processing method, and a recording medium capable of improving upon the above related art.

An information processing device according to an aspect of the present disclosure is for determining a countermeasure against an attack on an electronic control unit mounted in a moving body. The electronic control unit includes two or more separate areas separated by one or more virtual machines or one or more containers. The information processing device includes: an obtainer that obtains a result of monitoring the two or more separate areas; a determiner that determines one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and an outputter that outputs information for taking the one countermeasure determined.

An information processing method according to an aspect of the present disclosure is to be executed by an information processing device that determines a countermeasure against an attack on an electronic control unit mounted in a moving body. The electronic control unit includes two or more separate areas separated by one or more virtual machines or one or more containers. The information processing method includes: obtaining a result of monitoring the two or more separate areas; determining one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and outputting information for taking the one countermeasure determined.

A recording medium according to an aspect of the present disclosure is a non-transitory computer-readable recording medium having recorded thereon a program for causing a computer to execute the information processing method described above.

According to an aspect of the present disclosure, an information processing device, and so on, can be achieved which can determine a more suitable countermeasure when a security risk is detected.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 shows a configuration of a vehicle system according to an embodiment.

FIG. 2 is a block diagram showing a functional configuration of an integrated ECU according to the embodiment.

FIG. 3 is a flowchart showing an operation of the integrated ECU according to the embodiment.

FIG. 4 shows example detection information according to the embodiment.

FIG. 5 is a flowchart showing a detailed operation in step S30 shown in FIG. 3.

FIG. 6 is a first diagram for illustrating calculation of accumulated influence scores according to the embodiment.

FIG. 7 is a second diagram for illustrating calculation of the accumulated influence scores according to the embodiment.

FIG. 8 is for illustrating calculation of function continuity scores according to the embodiment.

FIG. 9 shows example response information according to the embodiment.

FIG. 10 is for illustrating a countermeasure against a cyberattack.

### DESCRIPTION OF EMBODIMENT

### Circumstances Leading to the Present Disclosure

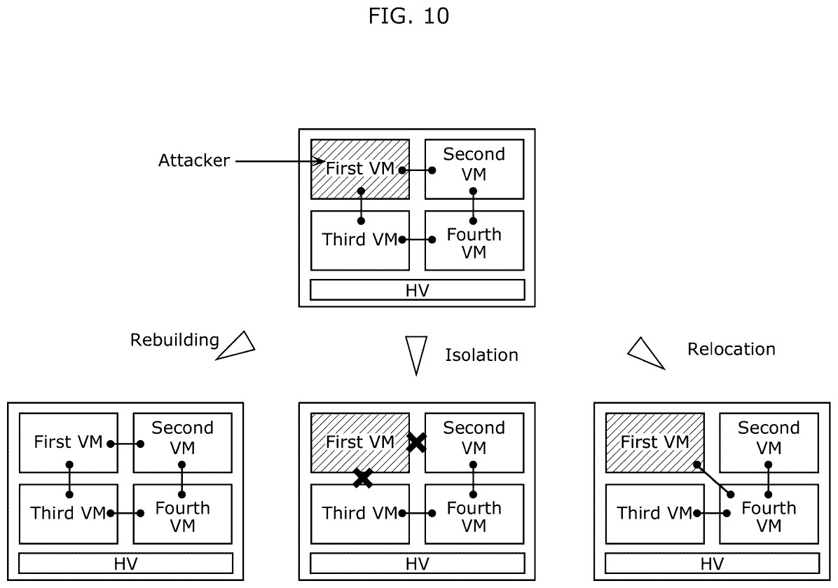

Prior to the description of the present disclosure, the circumstances leading to the present disclosure will be described with reference to FIG. 10. FIG. 10 is for illustrating a countermeasure against a cyberattack. FIG. 10 shows a configuration of an electronic control unit (ECU) and an example where the ECU includes four separate areas, namely, first to fourth virtual machines (VMs) on a hypervisor (HV). The first VM and the second VM, the first VM and the third VM, the third VM and the fourth VM, and the second VM and the fourth VM are communicably connected to each other. The VMs in which an attack has been detected are hatched. In place of or in addition to the VMs, the electronic control unit may include containers. In the following, if only a VM is described, this VM may be read as a container. That is, a “VM” described here may be read as a “VM or container”.

As shown in FIG. 10, if the first VM is attacked by an attacker, there is a fear that the attacker also attacks the communicably connected second and third VMs via the first VM, or the fourth VM via the second VM and the third VM. For example, there is a fear that an increasing VMs are hacked by the attacker.

As a countermeasure against the attack, rebuilding, isolation, and relocation are raised as examples. The rebuilding may be reinstalling a program, such as the operating system (OS) or software of the VMs (i.e., the separate areas), in which an attack has been detected, or turning off these VMs. The rebuilding may include reinstalling the programs of the separate areas in which an attack has been detected or suspending the power supply to these separate areas. Since the rebuilding interrupts the communications between the attacker and the VMs and can return the VMs to the states before the attack. FIG. 10 shows an example where the first VM is rebuilt. The rebuilding may be deleting the VMs in which an attack has been detected.

The isolation may be blocking the communications between the VMs (i.e., the separate areas), in which an attack has been detected, and all the other VMs in this electronic control unit. The isolation may be disconnecting the separate areas, in which an attack has been detected, from the other separate areas. The isolation can reduce the attacks reaching the other VMs via these VMs.

The relocation is changing the connection relations of the VMs (i.e., the separate areas). The relocation may be deleting the connection with the VMs in which an attack has been detected, and building a new VM connection. FIG. 10 shows an example where the connections between the first VM and the second VM and between the first VM and the third VM are deleted, and then a new connection between the first VM and the fourth VM is built. The relocation causes a VM, in which an attack has been detected, not to attack a predetermined VM directly, making the predetermined VM less vulnerable to attack. The predetermined VM may be, for example, a VM whose maximum degree of influence, which will be described later, is higher than or equal to a predetermined degree, or a VM in the top predetermined number.

Note that the countermeasures are not limited to these three but may include other countermeasures. Two or more countermeasures may suffice.

Here, determining a more suitable countermeasure is demanded. For example, determining a countermeasure on a rule basis is conceivable. There is however limit to determine, in advance, which one of two or more countermeasures is to be taken in a certain situation. As described above, an information processing device and so on against a security risk, such as a cyberattack, can be improved upon.

To address the problem, the present inventors have carefully studied, as an information processing device and so on that can be improved upon, information processing devices, and so on, which can determine a more suitable countermeasure, when a security risk is detected. The present inventors have thought of the following information processing device, and so on.

For example, determining a countermeasure based on a result of monitoring the behavior of a network or a communication packet is also conceivable. Laking in consideration of information on the VM, there is a fear that a suitable countermeasure according to the VM cannot be determined. For example, there is a fear that a suitable countermeasure according to the OS or the function of the VM cannot be determined.

To address the fear, the present inventors have carefully studied an information processing device that can determine a suitable countermeasure according to the OS or the function of a VM.

The embodiment described below is a mere comprehensive or specific example of the present disclosure. The numerical values, shapes, elements, the arrangement and connection of the elements, steps, step orders etc. shown in the following embodiment are thus mere examples, and are not intended to limit the scope of the present disclosure. Among the elements in the following embodiment, those not recited in the independent claims will be described as optional.

The figures are schematic representations and not necessarily drawn strictly to scale. The scales are thus not necessarily the same in the figures. The same reference signs represent substantially the same configurations in the drawings and redundant description will be omitted or simplified.

In this specification, the numerical values and the numerical ranges do not have the exact meaning and include substantially equivalent ranges, such as errors of several percent (or about 10%).

### Embodiment

Now, a vehicle system, and so on, including an information processing device according to this embodiment will be described.

### 1. Configuration of Vehicle System

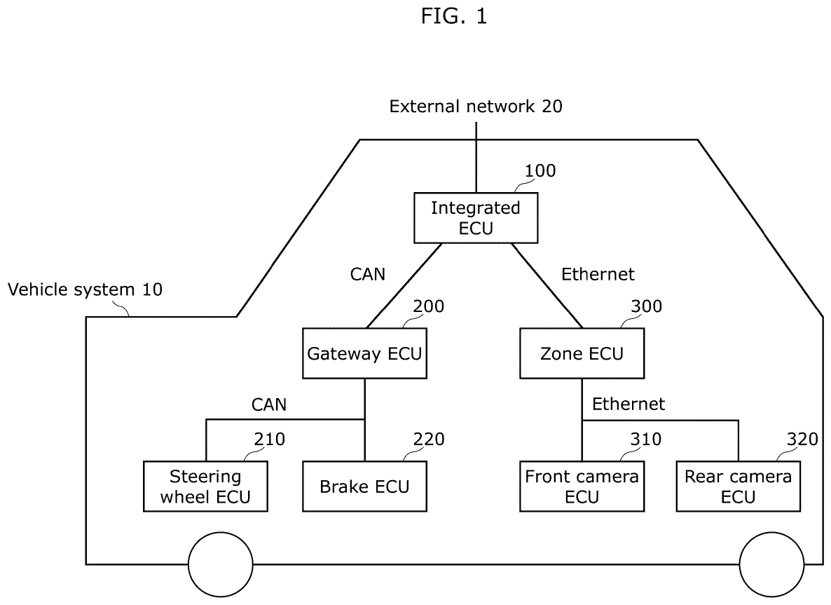

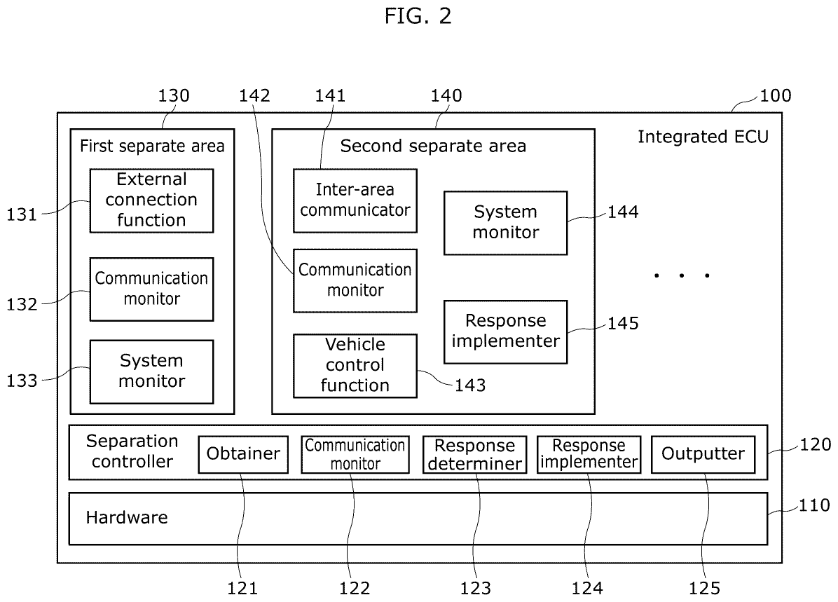

First, a configuration of the vehicle system will be described with reference to FIGS. 1 and 2. FIG. 1 shows a configuration of vehicle system 10 according to this embodiment.

As shown in FIG. 1, vehicle system 10 is mounted in a vehicle (i.e., an example of the moving body), such as an automobile, and includes integrated ECU 100, gateway ECU 200, steering wheel ECU 210, brake ECU 220, Zone ECU 300, front camera ECU 310, and rear camera ECU 320.

Integrated ECU 100 and gateway ECU 200 are communicably connected to each other via a control area network (CAN) which is one of network protocols. Here, the network protocol is not necessarily the CAN and may be any protocol, such as CAN-flexible data rate (FD) or FlexRay (registered trademark), used in an existing vehicle system.

Integrated ECU 100 and Zone ECU 300 are communicably connected to each other via Ethernet (registered trademark) which is one of network protocols. Ethernet is, for example, a Scalable service-Oriented MiddlewarE over IP (SOME/IP) protocol. Here, the network protocol is not necessarily the SOME/IP and may be any protocol, such as SOME/IP-service discovery (SD) or CAN-extended length (XL), used in an existing vehicle system.

Integrated ECU 100 is for executing: communication control for exchanging messages via external network 20, the CAN, and Ethernet; vehicle control for making instructions on vehicle control to gateway ECU 200 and Zone ECU 300 via the CAN and Ethernet; and display control for outputting videos to an infotainment system and an instrument panel mounted in the vehicle. Integrated ECU 100 is also for notifying, via external network 20, an external server (not shown) of an anomaly detected by integrated ECU 100. In this embodiment, integrated ECU 100 executes a process of determining a countermeasure against an attack on an electronic control unit mounted in the vehicle. Integrated ECU 100 is an example of the information processing device.

Gateway ECU 200 is for mediating messages exchanged among integrated ECU 100, steering wheel ECU 210, and brake ECU 220. Gateway ECU 200, steering wheel ECU 210, and brake ECU 220 are communicably connected to each other via the CAN.

Steering wheel ECU 210 is for controlling the steering by a steering wheel mounted in the vehicle.

Brake ECU 220 is for controlling a brake mounted in the vehicle.

Zone ECU 300 is for mediating messages exchanged among integrated ECU 100, front camera ECU 310, and rear camera ECU 320. Zone ECU 300, front camera ECU 310, and rear camera ECU 320 are communicably connected to each other via Ethernet.

Front camera ECU 310 is mounted at the front of the vehicle and is for obtaining videos from a front camera that captures the area in front of the vehicle.

Rear camera ECU 320 is mounted at the rear of the vehicle and is for obtaining videos from a rear camera that captures the area behind the vehicle.

Vehicle system 10 controls the motions, such as traveling, turning, and stopping, of the vehicle using ECUs for controlling the engine and body of the vehicle in addition to steering wheel ECU 210, brake ECU 220, front camera ECU 310, and rear camera ECU 320. Vehicle system 10 may achieve advanced driver assistance functions, such as autonomous driving, adaptive cruise control, or automatic parking, using an ECU for collecting information from various sensors, such as a global positioning system (GPS).

### 2. Configuration of Integrated ECU

Now, a configuration of integrated ECU 100 according to this embodiment will be described with reference to FIG. 2. FIG. 2 is a block diagram showing a functional configuration of integrated ECU 100 according to this embodiment.

As shown in FIG. 2, integrated ECU 100 includes hardware 110, separation controller 120, and two or more separate areas that are two or more software areas. Separation controller 120 forms a control mechanism. The functions of integrated ECU 100 are fulfilled by a processor, such as a CPU, of integrated ECU 100, for example, executing the programs stored in a memory of integrated ECU 100.

Hardware 110 is a chip (e.g., System on Chip (SoC)) and represents a machine or a device that can receive data, perform logical operations on the data, store the data, and display the data. The hardware is not limited thereto but may include a processor and a memory.

Separation controller 120 includes virtualization software to be executed on the hardware and for controlling the execution of the virtual machines (VM) or the containers. This separation controller 120 can virtualize and mount a plurality of different operating systems (i.e., two or more software areas) on single hardware 110. The virtualization software may include a hypervisor.

Separation controller 120 includes obtainer 121, communication monitor 122, response determiner 123, response implementer 124, and outputter 125. Obtainer 121, response determiner 123, and outputter 125 are not necessarily included in separation controller 120 but may be included in any of the functional blocks of integrated ECU 100.

Obtainer 121 is a processor that obtains detection information indicating the detection of an anomaly from communication monitors or system monitors.

Communication monitor 122 has a function of monitoring communications between inter-area communicators by obtaining the details of the communications between the inter-area communicators.

Response determiner 123 is a processor that determines a countermeasure based on a result of detecting an attack out of anomalies that have occurred in vehicle system 10. Response determiner 123 selects a countermeasure to be taken from the plurality of countermeasures based on the maximum degrees of influence obtained based on the detection information. The maximum degrees of influence is each the degree of influence that an attacker can exert on the vehicle (e.g., the travel of the vehicle) when hacking a separate area. The maximum degree of influence may represent the degree of influence of a security risk detected in the separate area on the function of this vehicle. Response determiner 123 is an example of the determiner.

Determiner 123 calculates the accumulated degree of influence based on, for example, the maximum degree of influence and the degree of influence when a countermeasure is taken. Based on the accumulated degree of influence calculated, determiner 123 selects the countermeasure to be taken from the plurality of countermeasures. The accumulated degree of influence is the time change in the degree of influence of an attacker on vehicle system 10, including the duration how long the attack by the attacker has an influence on vehicle system 10 (e.g., the accumulation of the degree of influence).

In this embodiment, in view of cyber resilience, response determiner 123 further selects the countermeasure to be taken from the plurality of countermeasures based on the degree of function continuity. The degree of function continuity indicates the degree of influence on the function of the vehicle when the countermeasure is taken (e.g., the degree of functions that may be impaired among the functions of entire vehicle system 10). The cyber resilience means keeping the influence of an attack at minimum, causing no shut-down of the system, and quick recovery to the original state.

Note that an attack (e.g., a cyberattack) is an example of the security risk. Examples of the security risk may include hacking, spoofing, and computer virus infection.

Response implementer 124 has a function of responding to an anomaly if detected by at least one of communication monitor 142 or system monitor 144.

Outputter 125 is a processor that outputs the information for taking the countermeasure determined by response determiner 123 to respective separate areas (e.g., respective response implementers).

The two or more software areas are separated by one or more virtual machines or one or more containers, and include first separate area 130 and second separate area 140 in this embodiment. In addition, the two or more software areas are executed on hardware 110. External connection function 131, communication monitor 132, and system monitor 133 belong to first separate area 130. An inter-area communicator may also belong to first separate area 130. On the other hand, inter-area communicator 141, communication monitor 142, vehicle control function 143, system monitor 144, and response implementer 145 belong to second separate area 140. Here, the functions belonging to first separate area 130, the functions belonging to second separate area 140, and the functions belonging to the other separate areas cannot interfere with each other without any predetermined communication means, because memories and namespaces are separated.

External connection function 131 has a function of being communicatively connected to the outside of the vehicle via external network 20. Specifically, external connection function 131 transmits, for example, a communication anomaly detected by communication monitor 132 and a system anomaly detected by system monitor 133 to an external server via external network 20. External connection function 131 downloads software from an external server (not shown) via external network 20 based on a software update instruction from the external server, for example.

Communication monitor 132 has a function of monitoring communications between inter-area communicators by obtaining the details of the communications between the inter-area communicators.

System monitor 133 has a function of separating the virtual machines or the containers, and monitoring the software of the respective areas.

Inter-area communicator 141 has a function of causing communications between the functions belonging to second separate area 140 and the functions belonging to first separate area 130, and between the functions belonging to second separate area 140 and the other separate areas.

Communication monitor 142 has a function of monitoring the communications between the other two inter-area communicators by obtaining the details of communications between the inter-area communicators of the other two separate areas (not shown). Specifically, communication monitor 142 monitors communications not in one area but between areas.

Vehicle control function 143 has a function of making instructions on vehicle control via a CAN and Ethernet. For example, vehicle control function 143 has a function of making instructions on the steering by the steering wheel of the vehicle.

System monitor 144 has a function of separating the virtual machines or the containers, and monitoring the software of the respective areas.

Response implementer 145 has a function of responding to an anomaly if detected by at least one of communication monitor 142 or system monitor 144.

Note that vehicle functions often need to cooperate across virtual machines or containers, and communications between virtual machines or containers are necessary. That is, the separate areas are communicable with each other.

In this embodiment, while a case will be described where two or more software areas are separated, the separation is not limited thereto. Three or more software areas may be separated. In this case, the three or more software areas include one first separate area 130 and one second separate area 140 described above. For example, if three software areas are separated, the three software areas include one first separate area 130 and two or more second separate areas 140. By finely separating the software areas in this manner, more efficient development becomes possible. A plurality of functions with different levels of risk can be separated into areas with different levels of risk, which can further improve security.

In this embodiment, while inter-area communicator 141 and response implementer 145 belong to second separate area 140, the attribute is not limited thereto. Inter-area communicator 141 and response implementer 145 may belong to first separate area 130.

In this embodiment, while second separate area 140 includes vehicle control function 143, the configuration is not limited thereto. Second separate area 140 may include a safety function which is at least one of: (i) an internal connection function of being communicably connected to an internal network (e.g., an in-vehicle network such as a CAN or Ethernet) constructed inside the vehicle; (ii) vehicle control function 143, (iii) a vehicle information providing function of providing vehicle information; (iv) a software update function; or (v) a security function.

### 3. Operation of Vehicle System

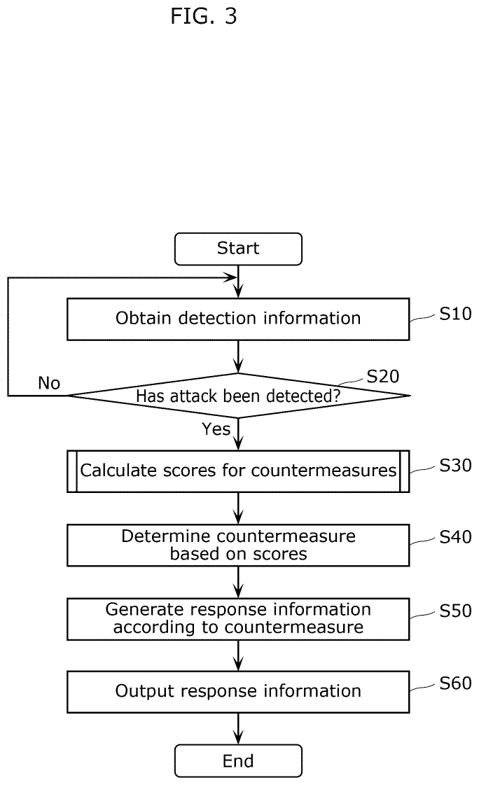

Subsequently, an operation of vehicle system 10 configured as described above will be described with reference to FIGS. 3 to 9. FIG. 3 is a flowchart showing an operation (i.e., the information processing method) of integrated ECU 100 according to this embodiment.

As shown in FIG. 3, first, obtainer 121 of integrated ECU 100 obtains, from a communication monitor or a system monitor, detection information indicating detection of an anomaly (S10). Examples of the detection information include an anomaly in an operation of one separate area or a result of monitoring communications between two or more separate areas.

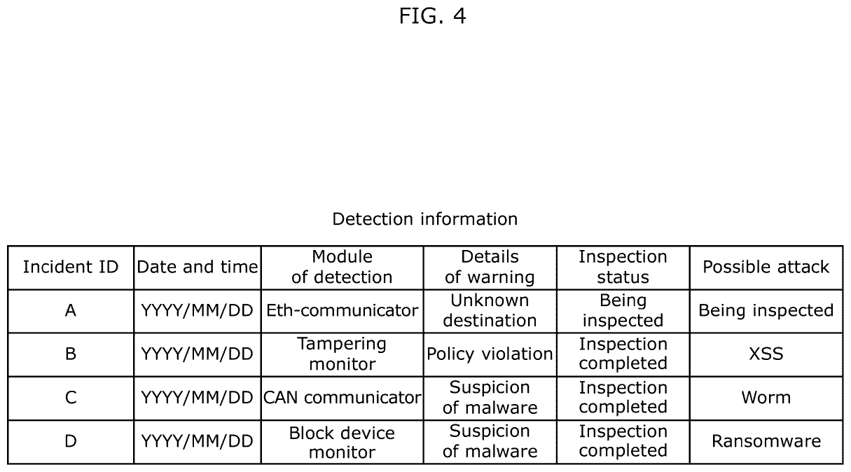

FIG. 4 shows example detection information according to this embodiment. The detection information shown in FIG. 4 indicates a list of anomalies detected by the communication monitor and the system monitor.

As shown in FIG. 4, the detection information includes “Incident ID”, “Date and time”, “Module of detection”, “Details of warning”, “Inspection status”, and “Possible attacks”.

The “incident ID” is the identification information of the incident. The “Date and time” is the date and time when the anomaly has been detected. The “Module of detection” is the module which has detected the anomaly. The “Module of detection” includes an “Eth-communicator”, which is a module that monitors communications via Ethernet or any other suitable protocol, a “Tampering monitor”, which is a module that monitors tampering, a “CAN communicator”, which is a module that monitors communications via a CAN, and a “Block device monitor”, which is a module that monitors block devices.

The “Details of warning” indicate the details of each anomaly. The “Inspection status” indicates the status of inspection for an anomaly. The “Possible attack” indicates the type of an anomalous attack.

Referring back to FIG. 3, response determiner 123 determines whether an attack has been detected based on the detection information (S20). Response determiner 123 may determine that an attack has been detected, for example, when an anomaly is detected, or may determine that an attack has been detected if there is a possible attack when the inspection status indicates “Inspection completed”.

Determining that an attack has been detected (Yes in S20), response determiner 123 calculates the scores for countermeasures set in advance (S30).

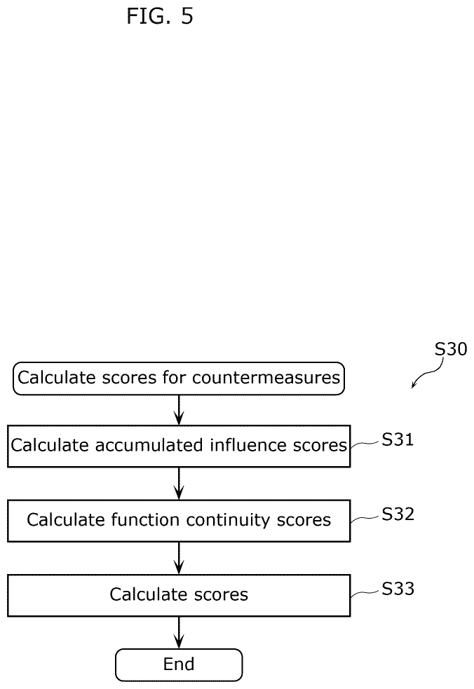

FIG. 5 is a flowchart showing the detailed operation (i.e., the information processing method) in step S30 shown in FIG. 3.

As shown in FIG. 5, response determiner 123 calculates the accumulated influence scores (S31), calculates the function continuity scores (S32), and then calculates the scores for the countermeasures based on the accumulated influence scores and the function continuity scores (S33).

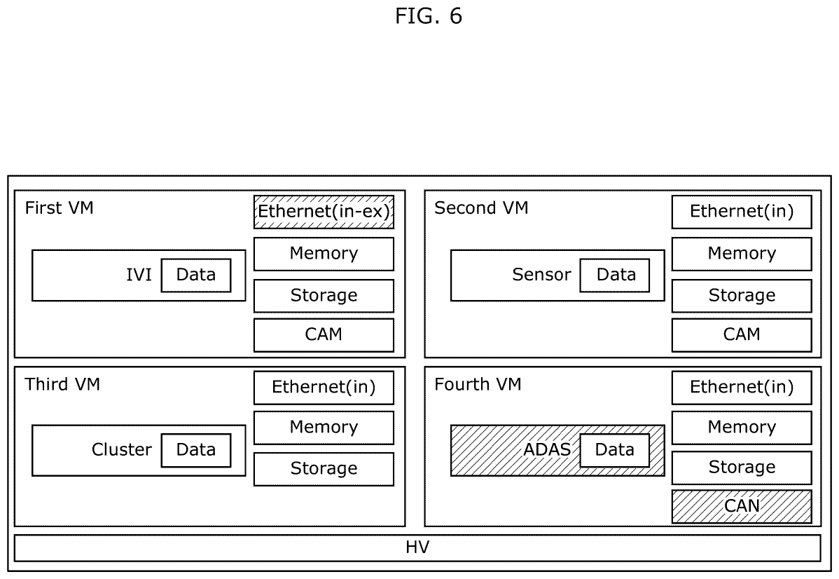

FIG. 6 is a first diagram for illustrating the calculation of the accumulated influence scores according to this embodiment. In the following, a method of calculating the accumulated influence scores in an integrated ECU with the configuration shown in FIG. 6 will be described for the sake of convenience.

As shown in FIG. 6, the integrated ECU includes four separate areas, namely, first to fourth VMs on a hypervisor (HV).

The first VM has an in-vehicle infotainment (IVI) function, and four functions or resources of: Ethernet (in-ex); a memory; a storage; and a CAN. The first VM communicates with an external device by means of Ethernet.

The second VM has a sensing function, and four functions or resources of: Ethernet (in); a memory; a storage; and a CAN.

The third VM has a Cluster function, and three functions or resources of: Ethernet(in); a memory; and a storage.

The fourth VM has an advanced driver-assistance systems (ADAS) function, and four functions or resources of: Ethernet(in); a memory; a storage; and a CAN.

When calculating the accumulated influence scores, response determiner 123 first calculates the maximum degree of influence of each VM (i.e., each separate area). Response determiner 123 calculates, as the maximum degree of influence, the degree of influence when the area is attacked by the information resource of the area. Response determiner 123 calculates the maximum degree of influence based on the impact values assigned to the functions of the VMs and the resources of the VMs. The impact values each indicates how much influence an attacker has on the functions of the vehicle when the attacker can control this function or resource. The impact value may indicate how much the attacker can manipulate the moving body when the attacker hacks the VM.

In the example of FIG. 6, the impact value (i.e., a first impact value) of the hatched functions and resources is set higher than the impact value (i.e., a second impact value) of the non-hatched functions and resources. An example will be described as follows where the first impact value is “2” and the second impact value is “1”. For example, in the first VM, Ethernet (in-ex) is an important function to communicate with an external device, such as a server, and is thus assigned with the first impact value.

Response determiner 123 calculates the maximum degree of influence of this VM by calculating the sum of the first impact value and the second impact value. For example, response determiner 123 calculates the maximum degree of influence of first VM as “6” (i.e., the first impact value×1+the second impact value×4), and the maximum degree of influence of the second VM as “5” (i.e., the first impact value×0+the second impact value×5). For example, response determiner 123 calculates the maximum degree of influence of the third VM as “4” (i.e., the first impact value×0+the second impact value×4), and the maximum degree of influence of the fourth VM as “7” (i.e., the first impact value×2+the second impact value×3).

In this manner, response determiner 123 determines the maximum degree of influence of each separate area in which an anomaly has been detected, through calculation according to the functions and the resources belonging to the separate area.

Note that the respective impact values of the functions and the resources may be set in advance and stored in a storage (not shown). The maximum degrees of influence of the VMs may be calculated in advance and stored in the storage.

Note that response determiner 123 may calculate the maximum degrees of influence in view of the OSs used in the VMs (i.e., the separate areas). For example, the degrees of influence may be set for OSs in advance and stored in a storage (not shown). The OSs are not particularly limited as long as being open to the public. Examples include Linux (registered trademark), Windows (registered trademark), and Android (registered trademark). The OSs are however not limited thereto.

Note that response determiner 123 may calculate the maximum degrees of influence, for example, by weighting the respective impact values of the functions and the resources and adding the weighted values. Response determiner 123 may calculate the maximum degrees of influence using the values converted from the impact values by a function set in advance, for example. Response determiner 123 may calculate the maximum degrees of influence by both the means.

Response determiner 123 then calculates, for each countermeasure and each VM, an accumulated degree of influence according to the maximum degree of influence of this VM and the degree of influence if the countermeasure is taken in this VM. The accumulated degree of influence is an example of the first degrees of influence.

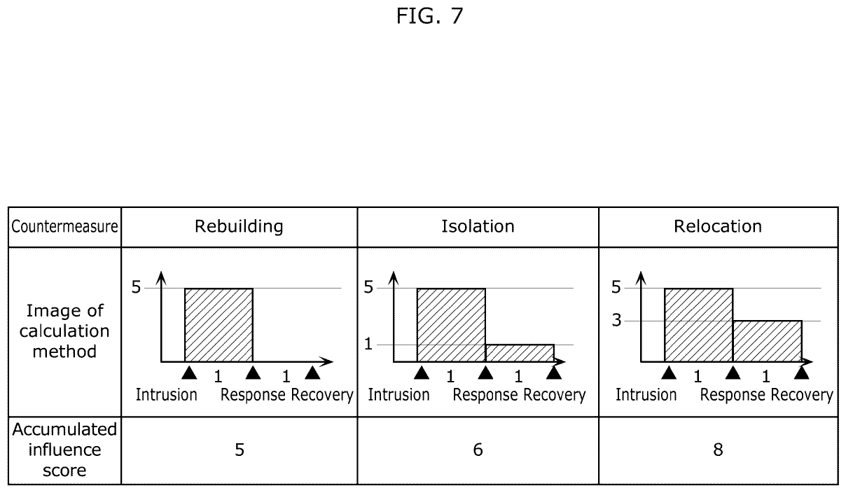

FIG. 7 is a second diagram for illustrating calculation of accumulated influence scores according to this embodiment. FIG. 7 shows an example where an anomaly is detected in the second VM and the accumulated influence scores of the second VM are calculated. In the image of each calculation method, the horizontal axis of the graph represents time, and the vertical axis represents the degree of influence. “Intrusion” represents the time when a cyberattack has been detected. “Response” represents execution of a countermeasure. “Recovery” represents recovery from the cyberattack (i.e., back to the state before the cyberattack). The time from “Intrusion” to “Response” and the time from “Response” to “Recovery” are set to “1” for the sake of convenience. In the vertical axis, “5” represents the maximum degree of influence of the second VM. In the following, the method of calculating accumulated influence scores in the integrated ECU with the configuration shown in FIG. 6 will be described for the sake of convenience.

As shown in FIG. 7, if the rebuilding is executed as the countermeasure, the VM is back to the state before the cyberattack (i.e., the state without being subjected to the cyberattack). The degree of influence after “Response” is thus “0” in the graph. Accordingly, response determiner 123 obtains “5” (from 5×1+0×1) as the accumulated influence score for the rebuilding.

If the isolation is executed as the countermeasure, Ethernet or any other suitable protocol does not function in this VM. The degree of influence in the isolation is determined based on the impact value of a function and a resource remaining as a function (i.e., valid). In the second VM, the sensor functions even after the isolation, the degree of influence after “Response” is thus “1” in the graph. In this manner, the sum of the degrees of influence of the functions effective even after the isolation serves as the degree of influence after “Response” in the graph. Accordingly, response determiner 123 obtains “6” (from 5×1+1×1) as the accumulated influence score for the isolation.

If the relocation is executed as the countermeasure, this VM and another VM, which have been connected, are not directly connected (i.e., no cyberattack can be made to the other VM without any other VM). The degree of influence after the response is thus “3” in the graph. This is because the other VM is not completely shut off and “3” is thus determined, which is a degree of influence higher than in the isolation and lower than the maximum degree of influence. Accordingly, response determiner 123 obtains “8” (from 5×1+3×1) as the accumulated influence score for the relocation.

In step S31, the accumulated influence scores are calculate as described above.

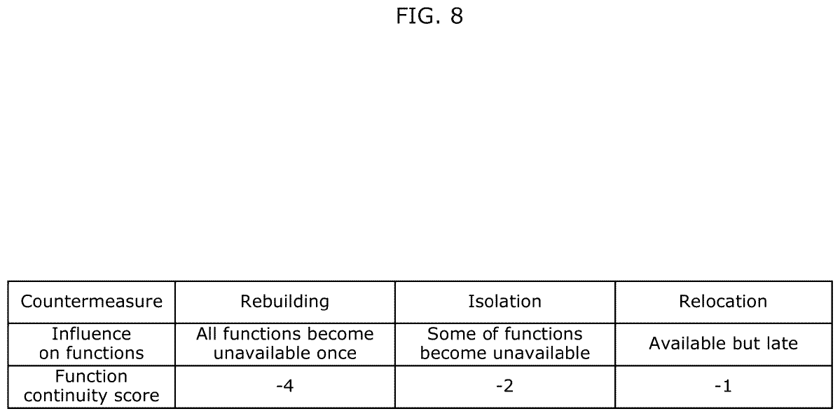

Now, calculation of function continuity scores will be described with reference to FIG. 8. FIG. 8 is for illustrating the calculation of the function continuity scores according to this embodiment. FIG. 8 shows an example where an anomaly is detected in the second VM and the function continuity scores of the second VM are calculated. In FIG. 8, the function continuity scores are negative values. In this case, the smaller the value of the function continuity score, the larger influence on the function (or the resource) of this VM.

As shown in FIG. 8, if the rebuilding is executed, all the functions (and the resources) of the VM become unavailable once. An influence on the functions larger than those in the isolation and the relocation, and a function continuity score lower than those in the isolation and the relocation are determined. In the example of FIG. 8, response determiner 123 determines “−4” as the function continuity score for the rebuilding.

If the isolation is executed, some of the functions (and the resources) of the VM become unavailable. An influence on the functions larger than that in the relocation, and a function continuity score lower than that in the relocation and higher than in the rebuilding are determined. In the example of FIG. 8, response determiner 123 determines “−2” as the function continuity score for the isolation.

If the relocation is executed, the functions (and the resources) of the VM become available late (i.e., it takes time). An influence on the functions larger than those in the rebuilding and the relocation is determined. In the example of FIG. 8, response determiner 123 determines “−1” as the function continuity score for the relocation.

In step S32, the function continuity scores are calculated as described above. The function continuity scores are each the degree indicating the function continuity in the separate area in which a countermeasure is taken, and an example of the second degrees of influence.

Next, in step S33, response determiner 123 calculates the score (i.e., an example of the total degree) for each countermeasure in the second VM in which an attack has been detected based on the accumulated influence score and the function continuity score. For example, response determiner 123 obtains one score through predetermined calculation on the accumulated influence score and the function continuity score. The predetermined calculation is addition, for example, but is not limited thereto.

For example, response determiner 123 determines “−9”, which is the sum of the accumulated influence score in the rebuilding with a minus sign and the function continuity score in the rebuilding, as the score for the rebuilding. Response determiner 123 determines “−8”, which is the sum of the accumulated influence score in the isolation with a minus sign and the function continuity score in the isolation, as the score for the isolation. Response determiner 123 determines “−9”, which is the sum of the accumulated influence score in the relocation with a minus sign and the function continuity score in the relocation, as the score for the relocation.

Referring back to FIG. 3, response determiner 123 determines the countermeasure based on the scores calculated in step S30 (S40). If the score is a negative value, response determiner 123 determines, as the countermeasure to be taken this time, the countermeasure with the score closest to zero (e.g., the largest value). In the examples in FIGS. 6 to 8, response determiner 123 determines, as the countermeasure in the second VM, the isolation with the score closest to zero.

If a security risk is detected in one of two or more separate areas based on the detection information, response determiner 123 determines the countermeasure against the security risk from the plurality of countermeasures based on at least the maximum degree of influence and the accumulated degree of influence. For example, response determiner 123 may determine, as the countermeasure to be taken, the countermeasure with the minimum degree of influence (here the countermeasure with the accumulated influence score closest to zero) based on the maximum degrees of influence and the accumulated degrees of influence of the plurality of countermeasures. Response determiner 123 may further determine the countermeasure against the security risk based on the degrees of function continuity indicating the function continuities of the moving body for the plurality of countermeasures where the plurality of countermeasures are taken. In this case, response determiner 123 may determine, as the countermeasure to be taken, the countermeasure with the minimum degree of influence (here the countermeasure with the sum of the accumulated influence score and the degree of function continuity closest to zero) based on the maximum degrees of influence, the accumulated degrees of influence, and the degrees of function continuity of the plurality of countermeasures.

In this embodiment, determining the countermeasure based on the total score of the accumulated influence score and the function continuity score, response determiner 123 can determine a countermeasure well balanced in terms of the cyber resilience.

Note that response determiner 123 may determine the countermeasure based on at least the accumulated degree of influence.

Next, response determiner 123 generates response information according to the determined countermeasure (S50).

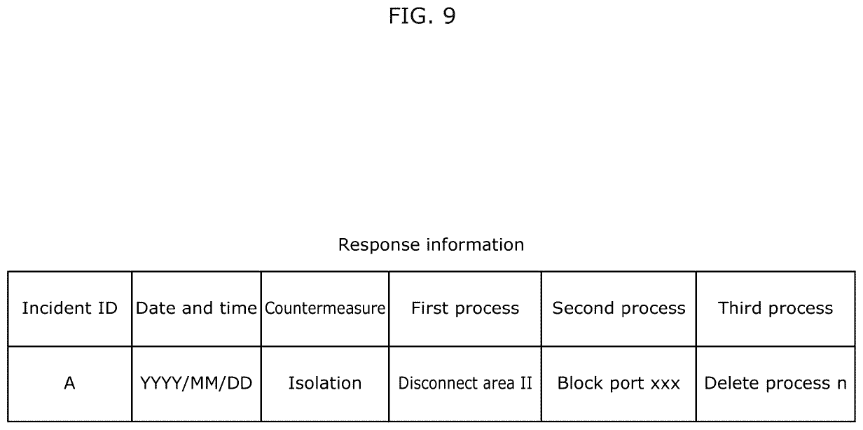

FIG. 9 shows example response information according to this embodiment. The response information shown in FIG. 9 is transmitted in common to the VMs (i.e., the separate areas). Note that FIG. 9 shows response information including a countermeasure against incident ID “A”.

As shown in FIG. 9, the response information includes the incident ID, the date and time, the countermeasure, and the first to third processes.

The countermeasure is that determined in step S40. The first to third processes are executed to achieve the countermeasure, and include here the process for isolating the second VM (i.e., the software area corresponding to the second VM). For example, response determiner 123 may generate response information using a table including countermeasures and processes to be executed to achieve the countermeasures in association.

Disconnecting area II is the process for disconnecting area II, which is the software area corresponding to the second VM, from the software areas of the other VMs. Blocking port xxx is the process for blocking communications through this port xxx. Disconnecting area II and blocking port xxx are the processes for isolating area II from the other areas.

Deleting process n is the process for deleting a predetermined program in the isolation target VM (here, the second VM). Since the cyberattack may continue on the isolation target VM even after the isolation, deleting is the process of deleting process n from the second VM not to cause the attacker to execute this process n.

Referring back to FIG. 3, next, outputter 125 outputs the generated response information (S60). Outputter 125 outputs the response information to the VMs (specifically, response implementers of the VMs) including the second VM. The response information is common among the VMs but may be respective information for VMs (i.e., information with details different from VM to VM).

Each VM obtains the response information and executes the process to be executed among the processes included in the obtained response information. For example, when a VM executes the first process and the second process, area II, to which the second VM belongs, is disconnected from the other separate areas and is no longer able to communicate with the other separate areas. For example, the second VM executes the third process not to execute process n.

Note that the taken countermeasure may continue until the vehicle is brought to a dealer or a repair shop, or may be stopped by a predetermined operation by the user.

Note that the information indicating which countermeasure has been taken, functions whose use is restricted by the execution of the countermeasure, or other information may be output and presented to the terminal device of the user in the vehicle.

### Other Embodiments

While the information processing device, and so on, according to one or more aspects has been described above based on the embodiment, the present disclosure is not limited to the embodiment. The present disclosure may include forms obtained by various modifications to the foregoing embodiment that can be conceived by those skilled in the art or forms achieved by freely combining the elements in the foregoing embodiment without departing from the scope and spirit of the present disclosure.

An example has been described above in the embodiment where the information processing device is mounted in a vehicle. The location is however not limited thereto. The information processing device may be mounted in a moving body, such as a train or an airplane, other than a vehicle: or on an electrical device, such as a mobile phone or home appliance.

An example has been described above in the embodiment where first separate area 130 and second separate area 140 are separated as virtual machines. The isolation is however not limited thereto. The areas may be separated by any isolation technique of virtual machines or containers.

An example has been described above in the embodiment where the scores of the countermeasures represent negative degrees in step S33. The degrees are not limited thereto. Determination may be made based on the positive degrees, for example.

An example has been described above in the embodiment where the degrees are represented by numerical values. The degrees are not limited thereto. The degrees may be stages, such as high, medium, low.

The information processing device according to the present disclosure may be achieved as a configuration including: a control mechanism; one or more separate areas operating in the control mechanism; a monitor (e.g., at least one of a communication monitor or a system monitor) that monitors operations of the separate areas and the control mechanism, and detects a suspicious behavior; a response determiner that is notified by the monitor, and determines how to respond to an anomaly; and a response implementer that is notified by the anomaly determiner and responds to the anomaly in operating the control mechanism and the separate areas.

In the embodiment described above, the elements may be achieved by dedicated hardware or by executing software programs suitable for the elements. The elements may be achieved by a program executor, such as a CPU or a processor, which reads out software programs stored in a recording medium, such as a hard disk or a semiconductor memory, and executes the read-out programs.

The order of executing the steps in the flowchart is a mere example for specifically describing the present disclosure and may be different. Part of the steps may be executed at the same time (i.e., in parallel) with another step or are not necessarily executed.

How to divide the functional blocks in the block diagrams are mere examples. The plurality of functional blocks may be achieved as one functional block, one functional block may be separated into a plurality of blocks, or part of functions may be transferred to another functional block. The similar functions of a plurality of functional blocks may be processed by single hardware or software in parallel or by time division.

The information processing device according to the embodiment described above may be a single device or include a plurality of devices. If the information processing device includes the plurality of devices, the elements of a monitoring device may be separated into the plurality of devices in any manner. If the information processing device includes the plurality of devices, how the plurality of devices communicate with each other is not particularly limited, and wired or wireless communications may be employed. Alternatively, wired or wireless communications may be combined between the devices.

The elements described above in the embodiment may be achieved by software, or may be typically achieved as a large-scale integration (LSI) circuit. These may be included in individual chips or some or all are included in one chip. While the system LSI circuit is named here, the integrated circuit may be referred to an IC, a system LSI circuit, a super LSI circuit, or an ultra-LSI circuit depending on the degree of integration. The circuit integration is not limited to the LSI. The devices may be dedicated circuits (general-purpose circuits executing dedicated programs) or general-purpose processors. A field programmable gate array (FPGA) programmable after the manufacture of an LSI circuit or a reconfigurable processor capable of reconfiguring the connections or settings of circuit cells inside an LSI circuit may be employed. Appearing as an alternative circuit integration technology to the LSI, another technology that progresses or deprives from the semiconductor technology may be used for integration of elements.

The system LSI circuit is a super multifunctional LSI circuit manufactured by integrating a plurality of processors on one chip, and specifically is a computer system including a microprocessor and a read-only memory (ROM), for example. The ROM stores computer programs. The microprocessor operates in accordance with the computer programs so that the system LSI circuit fulfills its functions.

According to an aspect, the present disclosure is directed to a computer program for causing a computer to execute the characteristic steps included in the information processing method shown in any of FIGS. 3 to 5.

For example, the program may be to be executed by a computer. An aspect of the present disclosure may be directed to a non-transitory computer-readable recording medium having such a program recorded thereon. For example, such a program may be recorded in a recording medium and distributed. For example, the distributed program is installed in a device including another processor and executed by the processor so that the device can perform the processing.

### Additional Notes

The description of the embodiment described above discloses the following techniques.

### Technique 1

An information processing device is for determining a countermeasure against an attack on an electronic control unit mounted in a moving body. The electronic control unit includes two or more separate areas separated by one or more virtual machines or one or more containers. The information processing device includes: an obtainer that obtains a result of monitoring the two or more separate areas; a determiner that determines one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and an outputter that outputs information for taking the one countermeasure determined.

Accordingly, the countermeasure can be determined in view of the degree of influence of the separate area, in which a security risk is detected, on the vehicle system. For example, a countermeasure according to the separate area can be determined. As a result, an information processing device can be achieved which can determine a more suitable countermeasure when a security risk is detected.

### Technique 2

Technique 2 is an embodiment of the information processing device according to Technique 1. In Technique 2, the first degrees of influence are each determined based on a function and a resource belonging to the one separate area.

Accordingly, the countermeasure can reflect the function and the resource belonging to the separate area. As a result, an information processing device can be achieved which can determine a more suitable countermeasure when a security risk is detected.

### Technique 3

Technique 3 is an embodiment of the information processing device according to Technique 1 or 2. In Technique 3, the determiner determines to take one countermeasure having a lowest one of the first degrees of influence out of the plurality of countermeasures.

Accordingly, a countermeasure with less influence on the vehicle system can be determined.

### Technique 4

Technique 4 is an embodiment of the information processing device according to any one of Techniques 1 to 3. In Technique 4, the determiner further determines one countermeasure against the security risk out of the plurality of countermeasures based on second degrees of influence each indicating a degree of influence on the function of the moving body when the one countermeasure is taken.

Accordingly, the countermeasure can be determined in view of the influence of the countermeasure on the function of the moving body.

### Technique 5

Technique 5 is an embodiment of the information processing device according to any one of Techniques 1 to 4. In Technique 5, the second degrees of influence are each determined based on a degree indicating the function continuity in the one separate area when the one countermeasure is taken.

Accordingly, the countermeasure can reflect the degree indicating the function continuity.

### Technique 6

Technique 6 is an embodiment of the information processing device according to any one of Techniques 1 to 5. In Technique 6, the determiner calculates total degrees, each being a sum of an associated one of the first degrees of influence and an associated one of the second degrees of influence, for the plurality of countermeasures, and determines to take one countermeasure with a lowest one of the total degrees out of the plurality of countermeasures.

Accordingly, a countermeasure having less influence on the vehicle system can be determined.

### Technique 7

Technique 7 is an embodiment of the information processing device according to any one of Techniques 1 to 6. In Technique 7, the plurality of countermeasures include at least two of: rebuilding including reinstalling a program owned by the one separate area or suspending power supply to the one separate area; isolation including disconnecting the one separate area from others of the two or more separate areas; or relocation including changing connection relations of the two or more separate areas.

Accordingly, a more suitable one of at least two countermeasures of rebuilding, isolation, or relocation can be determined.

### Technique 8

An information processing method according to an aspect of the present disclosure is to be executed by an information processing device that determines a countermeasure against an attack on an electronic control unit mounted in a moving body. The electronic control unit includes two or more separate areas separated by one or more virtual machines or one or more containers. The information processing method includes: obtaining a result of monitoring the two or more separate areas; determining one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and outputting information for taking the one countermeasure determined.

The method provides at least the same advantages as the information processing device described above.

### Technique 9

A non-transitory computer-readable recording medium having recorded thereon a program is program for causing a computer to execute the information processing method according to Technique 8.

The program provides at least the same advantages as the information processing device described above.

### Further Information About Technical Background to This Application

The disclosure of the following patent application including specification, drawings, and claims is incorporated herein by reference in its entirety: Japanese Patent Application No. 2025-052155 filed on Mar. 26, 2025.

### Industrial Applicability

The present disclosure is useful for an information processing device, and so on, that monitors an electronic control unit including a plurality of software areas.

1. An information processing device for determining a countermeasure against an attack on an electronic control unit mounted in a moving body, the electronic control unit including two or more separate areas separated by one or more virtual machines or one or more containers,
the information processing device comprising:
an obtainer that obtains a result of monitoring the two or more separate areas;
a determiner that determines one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and
an outputter that outputs information for taking the one countermeasure determined.

2. The information processing device according to claim 1, wherein the first degrees of influence are each determined based on a function and a resource belonging to the one separate area.

3. The information processing device according to claim 1, wherein
the determiner determines to take one countermeasure having a lowest one of the first degrees of influence out of the plurality of countermeasures.

4. The information processing device according to claim 1, wherein
the determiner further determines one countermeasure against the security risk out of the plurality of countermeasures based on second degrees of influence each indicating a degree of influence on the function of the moving body when the one countermeasure is taken.

5. The information processing device according to claim 4, wherein
the second degrees of influence are each determined based on a degree indicating the function continuity in the one separate area when the one countermeasure is taken.

6. The information processing device according to claim 4, wherein
the determiner calculates total degrees, each being a sum of an associated one of the first degrees of influence and an associated one of the second degrees of influence, for the plurality of countermeasures, and determines to take one countermeasure with a lowest one of the total degrees out of the plurality of countermeasures.

7. The information processing device according to claim 1, wherein
the plurality of countermeasures include at least two of:
rebuilding including reinstalling a program owned by the one separate area or suspending power supply to the one separate area;
isolation including disconnecting the one separate area from others of the two or more separate areas; or
relocation including changing connection relations of the two or more separate areas.

8. An information processing method to be executed by an information processing device that determines a countermeasure against an attack on an electronic control unit mounted in a moving body, the electronic control unit including two or more separate areas separated by one or more virtual machines or one or more containers,
the information processing method comprising:
obtaining a result of monitoring the two or more separate areas;
determining one countermeasure against a security risk out of a plurality of countermeasures based on first degrees of influence, when the security risk is detected in one separate area of the two or more separate areas based on the result of monitoring, the first degrees of influence each including: a degree of influence of the security risk detected in the one separate area on a function of the moving body; and a degree of influence of the security risk on the function of the moving body when the one countermeasure is taken; and
outputting information for taking the one countermeasure determined.

9. A non-transitory computer-readable recording medium having recorded thereon a program for causing a computer to execute the information processing method according to claim 8.
